(19) United States
(12) Patent Application Publication
(10) Pub. No.: US 2013/0058376 A1
(43) Pub. Date: Mar. 7, 2013

(54) METHOD AND DEVICE FOR CHARACTERIZING SOLID MATERIALS, AND METHOD AND INSTALLATION FOR DETERMINING A THERMODYNAMIC CHARACTERISTIC OF PROBE MOLECULES

(71) Applicants: Bertrand Pavageau, Villenave D'Ornon (FR); Julien Jolly, Talence (FR)

(72) Inventors: Bertrand Pavageau, Villenave D'Ornon (FR); Julien Jolly, Talence (FR)

(73) Assignee: Rhodia Operations, Aubervilliers (FR)

(21) Appl. No.: 13/514,961

(22) PCT Filed: Dec. 8, 2010
(86) PCT No.: PCT/FR2010/052643

§ 371 Date: Nov. 21, 2012

(30) Foreign Application Priority Data
Dec. 8, 2009 (FR) 09 58754

(51) Int. Cl. G01N 25/20; G01K 13/00

(52) U.S. Cl. 374/29; 374/E13.001

(57) ABSTRACT

The invention proposes an improvement in the characterization of solid materials, by making it easier to be implemented while obtaining reliable and accurate results. According to the method in accordance with the invention;
a material to be characterized (M), in powdery form is placed in a well (4);
while the material (M) is heated up by applying a predetermined power (P), a radiative thermal flux (F) emitted by the material is measured, and
from the measurements relating to the radiative thermal flux (F), a characterization of the material (M) is inferred, related to the heat which this material loses by thermal conduction with the walls of the well (4).

The present invention relates to a method and device for characterizing solid materials. It also relates to a method and to an installation for determining a thermodynamic characteristic of probe molecules.

The interest of the invention is focused on the characterization of powdery materials in particular with regard to their morphology notably their grain size and thermodynamic behavior notably for thermally calibrating them, in a non-limiting way. Such powdery materials are for example used in various applications for treating gases, for example for decontamination purposes.

The determination of such characteristics presently proves to be difficult. If one takes the example of determining a grain size value for this kind of powdery material, the existing methods are generally based on the use of a series of sieves which are increasingly fine, through which the material is passed so as to sort out the grains which make it up. In the case of establishing a thermal calibration of this kind of material, it is possible to resort to a calorimeter. In every case, specific pieces of equipment are required, the use of which is often delicate and tedious.

Thus, DE-A-103 08 741 proposes in a first phase to heat up by means of a pulsed heating source, a powdery material for which determination of the grain size is sought, and then in a second phase following the aforementioned phase, to measure the cooling flow from the particles of the material: it is then possible to quantify the size of these particles since those of small sizes cool more rapidly than the largest. This method therefore requires succession of a heating time and of a measurement time, which extends the overall duration, while limiting the accuracy of the estimation of the calculated grain size.

The object of present invention is to propose a method and a device which are easier and faster to apply, with which reliable and accurate characterization results may be obtained.

For this purpose, the object of the invention is a method for characterizing a solid material, as defined in claim 1.

The object of the invention is also a device for characterizing solid materials, as defined in claim 14.

The idea at the basis of the invention is to provide in the form of heat, power of a known value to a powdery material to be characterized, while simultaneously observing the radiative thermal flux which this material then emits as a response: by establishing a heat balance, i.e. by comparing the amount of energy brought to the material and the amount of energy which is removed at the same time, one has access to the thermal losses of the material. These thermal losses are explained by the presence of walls of the well in which the investigated material is received: indeed, because of the contact between the material and the walls of the well, a portion of the applied power is lost by thermal conduction in these walls. This consideration is of remarkable interest when the interest is more finely focused on the contact interface between the material and the walls of the well: because of the powdery morphology of the material, this contact interface does not correspond to an extended area continuously surrounding the material, but consists in a multitude of small contact areas between the walls and the peripheral grains of the material. The result of this is that by utilizing, notably with infrared thermography, the <<thermal response>> of the powdery material subject to the aforementioned predetermined power, it is possible in a reliable and accurate way to typically determine by suitable calculations, relevant characterizations of this powdery material, which take its morphology into account. Examples in this sense are provided subsequently.

It is emphasized here that in the sense of the invention, the notion of <<powdery material>> does not refer back to a pre-existing strict classification relating to powders. On the contrary, the invention generally apples to materials having a finely divided or porous solid structure, establishing a granular contact interface with the walls of the wells in which the material is placed.

In practice, the invention is particularly easy to apply. In particular, sifting or sealably confining the material to be characterized is not required. Further, measurements of the thermal response of this material are conducted by direct observation of the material simultaneously with its heating up by application of the pre-determined power. It is therefore understood that the corresponding manipulation times are short and may be rapidly linked: this may somewhat be referred to as a <<high throughput>> characterization. The application of the invention therefore proves to be economical, all the more since a small amount of material is sufficient for having reliable and significant data, considering the accuracy of the obtained thermal responses and the performance of the measurements relating to these thermal responses. Typically, the mass of the thereby characterized material is less than 100 mg.

As shown in more detail subsequently, with the invention, it is possible to determine morphological characteristics of the powdery material, in particular its grain size and its content of fines. With the invention it is also possible to establish a thermal calibration of the material, notably with view to using the latter for determining thermodynamic characteristics, such as enthalpy, of a gas probe molecule intended to be adsorbed on the material.

Thus, advantageous additional features of the method and device according to the invention, taken individually or according to all the technically possible combinations, are specified in the dependent claims 2 to 10 and 15 to 17.

The object of the invention is also a method for determining a thermodynamic characteristic of probe molecules, as defined in claim 11.

Advantageous features of this determination method are specified in the dependent claims 12 and 13.

The object of the invention is also an installation for determining a thermodynamic characteristic of probe molecules, as defined in claim 18.

The invention will be better understood upon reading the following description given as a non-limiting illustration and made with reference to the drawings wherein:

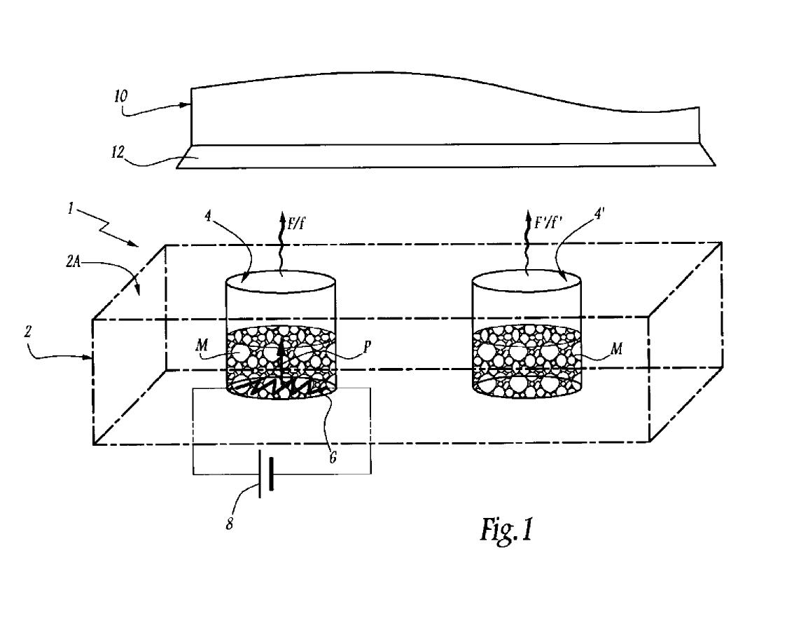

FIG. 1 is a diagram of a characterization device according to the invention;

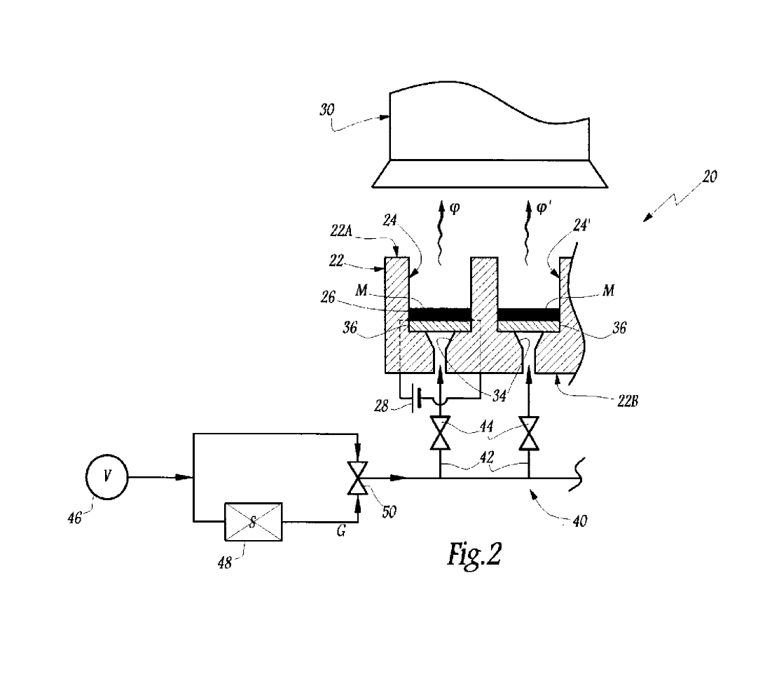

FIG. 2 is a diagram of a determination installation according to the invention;

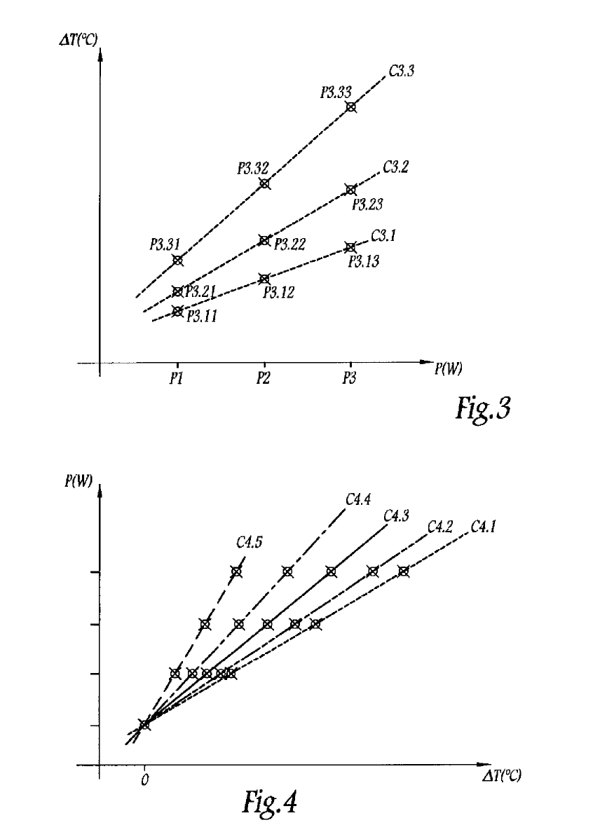

FIG. 3 is a graph illustrating the variation, versus power, of temperature measurements of three samples of a same material, having different grain sizes, carried out within the scope of a first example of the invention;

FIG. 4 is a graph illustrating the variation of power versus temperature measurements of several samples of a same material having different contents of fines, carried out within the scope of a second example of the invention;

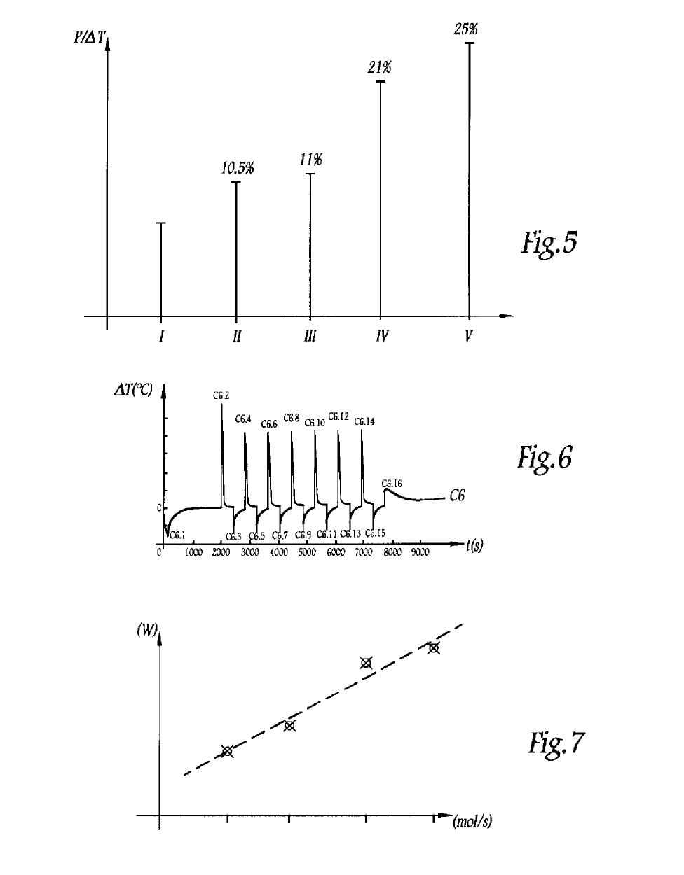

FIG. 5 is a graph illustrating the power/temperature ratio for the various samples of the second example;

FIG. 6 is a graph illustrating the variation versus time of temperature measurements of a material, carried out within the scope of a third example of the invention; and

FIG. 7 is a graph illustrating a correlation between a portion of the measurements of FIG. 6 and a flow rate and this for several values of this flow rate.

The device 1 according to the invention, schematically illustrated in FIG. 1, comprises a block 2 in which a well 4 is delimited. The well 4 is, at one of its ends, freely open on the outside, opening onto a face 2A of the block 2. At its opposite end, the well 4 is closed by a bottom 4A.

In practice, the block 2 is made in various forms and materials. In the illustrated example, this block 2 is made in a single piece, in stainless steel.

The wall 4 is adapted for interiorly receiving a material M to be characterized, provided as a powder or the like and deposited on the bottom 4A of the well, with interposition of an electric heating resistor 6. This heating resistor 6 thus covers at least partly the bottom 4A of the well 4, so as to be itself covered substantially homogeneously with the material M, as illustrated in FIG. 1. As an example, the heating resistor 6 consists in a tin wire which extends along a windy line, on the bottom 4A of the well 4.

The heating resistor 6 is electrically connected to an adjustable voltage generator 8. When operating, the electric power supply of the resistor 6 with the generator 8 allows application to the material M of an adjustable predetermined power P, which corresponds to the power consumed by the resistor and which heats up the material M.

The device 1 also comprises an infrared camera 10, the objective 12 of which is positioned facing the face 2A of the block 2. Of course, this camera may just as well be positioned so that its optical axis is perpendicular to the face 2A of the block: in this case, the thermography measurement is ensured by means of a mirror positioned at 45° above this face 2A, allowing reflection of the thermal radiation towards the camera. With this configuration, it is possible to protect the camera in the case of emission of aggressive fluxes which may damage its integrity.

The camera 10 is adapted for detecting radiations in the infrared domain, specifically corresponding to the spectral range comprised between 7.5 and 13 μm, and for producing images from these radiations. As an example, the camera 10 is a camera marketed by FLIR Systems under the reference <<ThermoVision A20M>>, the output signals of which are processed by the software package <<ThermaCAM Researcher>> (registered trademark).

When operating, the images produced by the camera 10 are sent to computer processing means, not shown, capable of determining a representative value of the temperature of the object emitting the radiation detected by the camera. More specifically, by making available an absolute temperature value by means of the camera 10, the emissivity of the observed object requires to be known or measured beforehand by suitable radiative calibration. In practice, knowing the value of the absolute temperature is not necessary if the measured data are processed by comparing them with each other, as explained just hereafter. In the same vein, it is also possible to use the signal of the camera in grey levels.

Thus, in addition to the well 4, the block 2 delimits a well 4′ identical with the well 4 described above, with the only difference being that this well is without any resistor similar to the heating resistor 6. The advantage of this well 4′ will become apparent from the explanations provided hereafter relating to the generic operation of the device 1. In practice, this well 4′ may be delimited in the block 2, as shown in FIG. 1, or else the wells 4 and 4′ may be individualized, by being respectively delimited by small identical and distinct blocks or the like. In the latter case, the filling and if necessary the replacing of the walls are facilitated.

By means of a suitable control of the generator 8, the resistor 6 heats up the material M placed in the bottom 4A of the well 4, by applying the predetermined power P to this material. The grains of the material M then emit together a radiative thermal flux, as indicated by the arrow F in FIG. 1. This thermal flux F is detected by the camera 10 and utilized by the computer processing means connected to this camera, for determining a representative value of the temperature of the material M resulting from its heating up with the provided power P.

The thermal flux F represents heat energy which does not correspond to the totality of the energy transmitted to the material M by the heating resistor 6: indeed, the material M loses heat by thermal conduction with the walls of the well 4, notably with the bottom wall 4A and the lower end portion of the side wall of the well. More specifically, the amount of energy thereby lost by thermal conduction by the material M is directly related to the powder morphology of this material: indeed it is understood that the more the material M is finely divided, the higher is the sum of the contact interfaces between the grains of this material and the walls of the well 4, intensifying by as much, the thermal losses by conduction with these walls. In this context, the thermal flux F has a remarkable benefit since, by knowing the value of the power P applied to the material M, it is possible to characterize the powder morphology of the material M, as illustrated by Examples 1, 2 and 3 hereafter.

Advantageously, the measurement of the thermal flux F by the camera 10 is continued after having suddenly cut off the application of the power P, by stopping the generator 8. In this way, the thermal radiation from the material M passes from the flux F of a stable mode to a flux f of a transient mode, related to stopping the heat propagation from the central region of the material M where the power P is mainly or even exclusively applied, towards the walls of the well 4, notably towards the side wall of this well. Like for the thermal flux F, this thermal flux f gives the possibility of inferring characterizations of the material M related to its powdery morphology, as illustrated by Example 3 hereafter.

Advantageously, during the use of the device 1, the well 4 is pairwise associated with the well 4′. In this way, provided that the wells 4 and 4′ contain the same amount of powdery material M, the difference between the measurement of the thermal flux F or f from the well 4 and the measurement of a similar thermal flux F′ or f′ from the well 4′ may be calculated in order to make available a thermal datum relating to the material M which is not influenced by the emissivity of the device and/or by thermal fluctuations of the conditions during the course of these measurements. In other words, the well 4′ is used as a reference for comparison with the thermal measurements relating to the well 4.

What has just been described for the well 4 or the pair of wells 4 and 4′ may be carried out simultaneously or sequentially, for several wells or pairs of similar wells, which are either delimited in the block 2, or individualized without being integrated into a same block, as mentioned above for the wells 4 and 4′. Thus it is possible to significantly increase the total number of wells and therefore the number of samples of material(s) to be characterized. Of course, the camera 12 then has sufficient spatial resolution for distinguishing the respective thermal fluxes from these different wells, so as to individually utilize the data corresponding to each of these fluxes.

In practice, the amount of material M present in the wells 4 and 4′ is small: it is typically less than 100 mg. Further, the device 1 is advantageously controlled through a control interface, such as a <<Labview >> interface. This control interface in particular controls the generator 8.

The device 1 and the method applying it, may be applied to various materials M. A preferential list of inorganic materials M is the following: alumina, silica, zeolite, alumino-silicate minerals, rare earth oxides (cerium, lanthanum, praseodymium, zirconium oxides, etc., either alone or as a mixture), and one of the aforementioned materials loaded with at least one noble metal selected from gold, platinum, palladium, etc.

The material M may also be organic, from the moment that it has morphology characteristics which are suitable for the invention (finely divided solid and/or with great porosity): it then notably consists in polymers, such as polyamines, polyphosphazenes and phosphorus-containing derivatives, or else in organic molecules with low molar mass.

Of course, it is even possible to characterize hybrid solid materials, i.e. having both inorganic and organic chemical functions.

The device 1 and the method applying it, allows characterization, inter alia, of the morphology of the material M, in particular its grain size, as in Example 1 hereafter, as well as its content of fines, as in Example 2 hereafter. Another possible characterization by the invention relates to thermal calibration of the material M with view to using this material for determining thermodynamic characteristics of a gas probe molecule, like in Example 3 hereafter, by means of the advantageous use of the installation 20 of FIG. 2, described hereafter in more detail.

The installation 20 comprises a block 22, which is similar to the block 2 and in which are delimited wells 24 and 24′, respectively similar to the wells 4 and 4′. In particular, the well 24 is associated with an electric heating resistor 26 similar to the resistor 6 and associated with an electric generator 28, similar to the generator 8. Also, the installation 20 comprises an infrared camera 30 similar to the camera 10.

With respect to block 2, block 22 has additional facilities. The bottom 24A, 24′A of each well 24, 24′ is connected through a conduit 34, delimited in the block, to the face 22B of the block, opposite to its face 22A into which the wells open out.

Further, a sintered element 36 extends through the mouth of each conduit 34 in the wells 24, 24′, while resting on the bottom 24A, 24′A of this well and thereby forming a support for the powdery material M. The sintered elements 36 have selected porosity so that the element mechanically supports the powdery material M without the latter infiltrating the pores of the sintered elements on the one hand and, that the element is not gas-proof, i.e. this element may be crossed right through by a gas flow, on the other hand. Typically, the pores of the sintered elements 36 have a size of the order of one micrometer.

Moreover, as an option not shown, the block 22 is thermostatic, i.e. its operating temperature may be imposed at an adjustable value by means of a thermostat. This thermoregulation may both be applied onto the whole of the block 22, in the sense that all the wells of this block then have a common operating temperature, and be individually applied to each well. In practice, the corresponding thermoregulation means may assume various forms, such as electric heating cartridges or a circuit for circulating a heat transfer fluid, integrated into the thickness of the block 22.

The installation 20 further comprises a gas supply circuit 40 for the conduits 34. More specifically, this circuit 40 includes gas inflows 42 which respectively feed the conduits 34, so as to respectively open into the bottom 24A, 24′A of the wells 24 and 24′. Each inlet 42 is provided with a solenoid valve 44 or a similar means, capable of controlling the flow rate of gas circulating in the corresponding inlet 42. Upstream from their solenoid valve 44, the inlets 42 are supplied with a gas mixture G containing a probe molecule S with a certain concentration.

In practice, the gas mixture G is made available in various ways. A first solution consists of having a source of this mixture, directly connectable to the input of the circuit 40. Another solution, illustrated in FIG. 2 consists of producing the gas mixture G from a source 46 of a carrier gas V feeding a unit 48 for producing probe molecules S. Advantageously, the circuit 40 gives the possibility in alternation with the gas mixture G, of feeding the inlets 42 with a gas without any probe molecules. In the illustrated example, the source 46 of carrier gas V may be used for this purpose, the use of a multi-way valve 50 placed upstream from the solenoid valves 44 and fed with the gas mixture from the unit 48 on the one hand and directly fed by the source 46 on the other hand.

Before further describing, within the scope of Example 3 hereafter, a specific use of the installation 20, its generic operation is described hereafter.

In a first phase, the installation 20 is used in the same way as the device 1, described above. As mentioned earlier and as illustrated in more detail in Example 3 hereafter, this first phase of use notably allows thermal calibration of the material M present in the wells 24 and 24′.

At the end of this first operating phase, the presence of the heating resistor 26 is no longer of interest for continuing the operation, so that it may, if necessary, be withdrawn.

In a second phase, some gas mixture G feeds the bottom 24A of the well 24, by passing through the corresponding inlet 42, with suitable control of the associated solenoid valve 44. After having crossed right through the sintered element 36, this gas mixture G attains the powdery material M and advances in the thickness of the latter, by flowing into the free spaces between the grains of this material, until it totally crosses the material. In other words, gas percolation of the material M is achieved inside the well 24. The probe molecules S contained in the gas mixture G then interact with the grains of the material M: this interaction depending on the cases may be of physical, chemical or physicochemical nature. In every case, the interest is focused on the thermal phenomena related to this interaction. In other words, depending on whether this interaction is exothermic or endothermic, the grains of the powdery material M emit together from their surface, a radiative thermal flux, as indicated by the arrow φ in FIG. 2.

This thermal flux φ is detected by the camera 30 and then utilized by computer processing means connected to this camera, in order to determine a representative value of the surface temperature of the material M resulting from its interaction with the probe molecules 5: in this context, the thermal flux φ has a remarkable property related to the intimate percolation contact between the grains of the material and the gas mixture G containing the probe molecules S on the one hand and the thermal insulation of the interaction between the material and these probe molecules, by the gas percolation phase in which the material M is <<immersed>>.

Like for the device 1, the amount of the material M present in the well 24 of the installation 20 is small: it is typically less than 100 mg. Further, it is understood that the flow rate of the gas mixture G in the inlet 42 is selected to be sufficiently low so as to obtain the sought percolation effect, notably by avoiding that this gas mixture may lift or displace the grains of the material M which rest on the bottom 24A of the well 24 and which permanently remain in contact with each other: the gas flow rate of the inflow 42 is typically less than a 100 mL/min, or even comprised between 10 and 70 mL/min. Advantageously, the sintered element 36 is involved in the homogenization of the flow of the gas mixture G flux just before it reaches and passes through the material M. Indeed, due to the small dimensions of the well 24, in particular of the conduit 34, the diameter of which is of the order of one millimeter, the flow of the gas mixture G is in a laminar mode and is focused on the mouth of the conduit 34 into the well 24: the sintered element 36 allows turbulences to be generated in the flow of the gas mixture and also allows spreading of the latter over the side of the material M turned towards this sintered element. In other words, the sintered element 36 <<breaks>> the flow of the gas mixture G which enters the well 24, while homogenizing this flow over the whole diameter of the well at the material M.

In practice, during the use of the installation 20, the well 24 is advantageously associated, as a pair, with the well 24′ so that the admission of gas mixture G into this well 24′ is obturated, by means of a corresponding control of the associated solenoid valve 44. Thus, by the difference between the measurement of the flux φ from the well 24 and the measurement of the flux φ′ from the well 24′, a thermal datum is available, which is not influenced by the emissivity of the installation and/or by thermal fluctuations of the outer environment, as explained above for the fluxes F and F′ from the wells 4 and 4′.

If necessary, the thermal regulation of the block 22 is active during the use of the installation 20: while the gas mixture G flows in a percolated way through the material M, the overall temperature of this material is imposed at an adjusted value, it being understood that thermal surface phenomena, resulting from the interaction between the material M and the probe molecule S, are superposed at the overall temperature of the thereby regulated material. In practice, this thermal regulation may over time be static or dynamic, this either by a ramp or by successive plateaus.

Of course, the installation 20 is advantageously controlled by a control interface, similar to the one mentioned for device 1. This control interface controls the circuit 40, in particular the solenoid valves 44, and, if necessary the unit 48 for producing probe molecules S and the thermoregulation thermostat of the block 22.

The installation 20 and its method for applying it, may be applied to various material M/probe molecule S pairs in order to determine thermodynamic characterization of this probe molecule S, in particular with view to determining the vaporization enthalpy of this probe molecule, as in Example 3 hereafter.

In practice, the material M is preferentially selected from the list defined above, in connection with device 1, while the probe molecule S is preferentially selected from hydrocarbons, soots, volatile organic compounds, in particular isopropanol, carbon monoxide, carbon dioxide, carboxylic acids, alkanes, alkynes, alkenes, alcohols, aromatic compounds, thiols, esters, ketones, aldehydes, amides, amines, N-propylamine, notably isopropylamine, ammonia, lutidine, pyridine, hydrogen, fluorine, neon, nitrile, quinoline, and a mixture of at least some of them.

Moreover, a preferential list of carrier gases V is the following: air, nitrogen, oxygen, argon, helium, and a mixture of at least some of them.

Three exemplary embodiments of the invention, notably using the device 1 or the installation 20, will now be described.

### EXAMPLE 1

This example relates to the characterization of silicas, as regards their grain size.

Three silicas are available for which the grain size has respective values different from each other. For each of the three silicas, a same mass of powder, for example 20 mg, is deposited in the well 4 and in the well 4′ of the block 2 of the device 1.

For each of the three pairs of wells 4 and 4′ respectively containing the three aforementioned silicas, the resistor 6 of the well 4 is electrically powered, while at the same time, the radiative thermal fluxes F and F′ emitted by the wells 4 and 4′ of each pair are then measured by means of the camera 10. The difference (ΔT) of the respective thermal measurements for wells 4 and 4′ of each aforementioned pair is plotted in FIG. 3, it being understood that this thermal difference is measured once that its value has stabilized over time: thus, under a first value of the power P, noted as P1, FIG. 3 shows three points P3.11, P3.21 and P3.31 respectively corresponding to the thermal measurements associated with each of the three silicas used.

The same measurements are repeated by modifying the value of the power applied to the three wells 4: a new series of measurements is conducted with the power value P2 (points P3.12, P3.22 and P3.32), as well as another series with the power value P3 (points P3.13, P3.23 and P3.33).

Considering the quasi-perfect alignment of the points P3.11, P3.12 and P3.13, on that of the points P3.21, P3.22 and P3.23, and on that of the points P3.31, P3.32 and P3.33, it is concluded that a correlation is relevant between the power applied to the silica grains and the thermal flux which they emit as a response, depending on the grain size of the silicas. In particular, the line C3.1, which substantially passes through the points P3.11, P3.12 and P3.13, has a smaller slope value than that of the line C2 which substantially passes through the points P3.21, P3.22 and P3.23, which itself has a smaller slope value than that of the line C3 which substantially passes through the points P3.31, P3.32 and P3.33. These observations are coherent with the fact that the grain size of the silica associated with the line C3.1 has a smaller value than that of the grain size of the silica associated with line C3.2, which itself has a smaller value than that of the grain size of the silica associated with line C3.3.

In order to proceed further, the inventors established a model for calculating the grain size of the material M, by means of preliminary calibrations for taking into account the influence of the mass of the material M deposited in the wells of the device 1, as well as the influence of the apparent density of the material used. This model is expressed by the following equation:

Grain size=K1+K2*mass+K3*apparent density,

wherein K1 is a parameter corresponding to the slope of a line obtained by measurements, in a similar way to the lines C3.1, C3.2 and C3.3 described above, and wherein K2 and K3 are numerical constants established by the aforementioned calibrations.

### EXAMPLE 2

Example 2 is focused on the characterization of a silica, as regards its content of fines.

A granular silica is available, for which it is sought to quantify and evaluate the mechanical strength when the silica grains are subject to mechanical stirring. To do this, five batches of this silica are prepared:
batch I corresponds to the silica in its original available state, i.e. without this silica having been subject to forced stirring;
batch II corresponds to the silica of batch I after having been subject to stirring with a dry ultrasonic bath for 30 minutes;
batch III corresponds to the silica of batch I having been subject to mechanical stirring via a powerful vortex, for 30 seconds;
batch IV corresponds to the silica of batch I having been subject to mechanical stirring via a powerful vortex, for 3 minutes; and
batch V corresponds to the silica of batch I having been subject to stirring with an ultrasonic bath for 2 minutes, before being dispersed in isopropanol subsequently evaporated at 80° C.

In each of the batches I to V, 20 mg of material are sampled, deposited in the well 4 of the device 1 on the one hand and 20 mg of material, deposited in the well 4′ on the other hand. By means of the camera 12, the radiative thermal fluxes F and F′ emitted by the wells 4 and 4′ are measured for each batch I, II, III, IV and V, and this for different values of the power P applied to the material of well 4. The measurement results are plotted in FIG. 4: each point shown in this figure has as an ordinate, one of the values of applied power and as an abscissa, the difference (ΔT) of the respective thermal measurements for the wells 4 and 4′. Like for Example 1, the experimental points obtained for each silica batch I, II, III, IV, V are substantially aligned while thereby defining lines respectively referenced as C4.1, C4.2, C4.3, C4.4 and C4.5.

FIG. 4 clearly shows that when forced mechanical stirring is accomplished on the silica used, the thermal datum ΔT is shifted to smaller values, gradually as the applied power P increases: this decrease in ΔT during the increase in the applied power, as compared with the situation of the silica of batch I, is explained by the increasingly marked presence of fines in the batches II, III, IV and V. Indeed, the presence of these fines increases the contact points between the walls of the well 4 and the grains of the silica: the losses by thermal conduction with the walls of the well therefore become more significant and consequently, the thermal datum ΔT detected by the camera 10 is smaller.

In FIG. 5, the ratio P/ΔT between the power applied to the material and the thermal datum ΔT is plotted, and this for the different tested batches I to V: it is clearly observed that the preparation of the batch V leads to significant alteration of the silica as compared with batch II.

It is moreover possible to evaluate the relative proportion of fines inside each batch, as compared with batch I: the thereby calculated relative percentage is written vertically above the plots respectively associated with the batches II to V, in FIG. 5.

### EXAMPLE 3

This example relates to the determination of the isopropanol adsorption enthalpy on silica. It is applied by means of the installation 20.

In a first phase, all the thermal losses which may occur in addition to the thermal phenomenon exclusively due to the absorption of isopropanol molecules on the silica will be estimated. In other words, during this first operating phase, the silica used is characterized so as to establish its thermal calibration.

A first cause of thermal losses relates to the losses by conduction with the walls of the well 24. By means of the same manipulations as the ones described above for Examples 1 and 2, it is possible to determine a correlation coefficient between the power P applied to the silica and the thermal datum ΔT corresponding to the difference in the respective thermal responses of the wells 24 and 24′.

A second cause of thermal losses relates to losses by natural convection, due to the contact of the silica with the ambient air just above the silica. However, considering the small dimensions of the well 24, the inventors observed that these losses by natural convection are negligible as compared with losses by conduction, notably because of the fact that the contact interface between the silica and the walls of the well is significantly more extended than the contact interface between the silica and the ambient air.

A third cause of thermal losses relates to the losses due to thermal diffusivity of the silica. This aspect is worth taking into consideration insofar, when the interest is focused during the second operating phase on the adsorption of the isopropanol on the silica, it might be of interest to take into account the fact that this adsorption does not occur in a strictly homogenous way in all the silica, but begins in the central region of the well 24 and then propagates into the remainder of the silica, notably towards the side wall of the well.

In order to estimate this diffusivity, a predetermined power P is applied on the silica, by means of the installation 20, and the application of this power is suddenly cut off: the stopping of the heat propagation towards the walls of the well 24 is then measured over time, by means of the camera 40. By renewing this manipulation for different values of the power P, a coefficient is inferred representing the thermal diffusivity losses of the silica.

In a second operating phase, adsorption and desorption cycles of isopropanol on the silica are carried out by means of the installation 20. Thus, FIG. 6 shows adsorption and desorption cycles:
during the first two thousand seconds, the well 24 is supplied with pure nitrogen in order to <<clean>> the silica, notably by desorbing water molecules present beforehand, which explains the cooling referenced as C6.1 in FIG. 6;
and then, for about two hundred seconds, the gas mixture G containing nitrogen and isopropanol molecules is circulated through the silica; isopropanol molecules are then adsorbed at the surface of the grains of this material and an exothermic phenomenon is observed, as shown by the peak referenced as C6.2 in FIG. 6;
and then, for about eight hundred seconds, circulation of the mixture containing isopropanol is interrupted, to the benefit of supplying exclusively nitrogen gas to the well 24; desorption of the isopropanol molecules adsorbed beforehand is observed, represented by a cooling peak C6.3;
and the adsorption cycle followed by the desorption cycle which has just been described is then repeated six times while thereby successively observing an exothermic peak C6.4 and an endothermic peak C6.5, and then again an exothermic peak C6.6 and an endothermic peak C6.7, and so forth up to an endothermic peak C6.15; and
finally in a last phase, the gas admission is totally interrupted in the well 24; however heating C6.16 is however observed, which is explained by the adsorption of water molecules present in the ambient environment.

The thermal profile of FIG. 6 is obtained for different flow rates of the gas mixture G and for each of the tested flow rates, the average of the areas measured for the five exothermic peaks C6.6, C6.8, C6.10, C6.12 and C6.14 is copied on the one hand and the maximum value of the thermal datum ΔT for the five aforementioned adsorption peaks is plotted on the other hand. It is then possible to estimate the power of the thermal flux φ corresponding to the adsorption phenomenon of isopropanol molecules on the silica, provided that the measured data ΔT are corrected with two coefficients of thermal losses calculated during the first operating phase.

FIG. 7 shows the correlation between the thereby calculated power of the thermal flux φ (in W) versus the flow rate of the gas mixture G (mol/s): the slope of the obtained line C7 corresponds to an experimental value of the vaporization enthalpy of isopropanol (J/mol).

This experimental result is reinforced by the value provided by scientific literature.

1-18. (canceled)

19. A method for characterizing solid materials, comprising:
placing a powdery material to be characterized in a well,
applying a predetermined power to heat said material,
measuring a first radiative thermal flux emitted by the material,
calculating an amount of heat lost by the material via heat conduction with a surface of the well based on the measurement of the first radiative thermal flux, and
determining a first characterization of the material based on the amount of heat lost.

20. The method of claim 19, further comprising measuring the first radiative thermal flux while the material is being heated.

21. The method of claim 19, wherein applying a predetermined power to heat the material comprises contacting and heating the material with an electric resistor that consumes the predetermined power.

22. The method of claim 19, further comprising measuring the first radiative thermal flux by infrared thermography.

23. The method of claim 19, wherein calculating the amount of heat lost by the material includes comparing the measurement of the first radiative thermal flux with a measurement of a first reference radiative thermal flux,
wherein the first reference radiative thermal flux is emitted by a reference material comprising the same type of material under the same conditions, with the exception that the predetermined power is not applied to the reference material.

24. The method of claim 23, further comprising measuring the first reference radiative thermal flux by infrared thermography.

25. The method of claim 19, wherein the first characterization comprises the powdery morphology of the material.

26. The method of claim 25, wherein the powdery morphology of the material comprises a grain size of the material.

27. The method of claim 25, wherein the powdery morphology of the material comprises a content of fines of the material.

28. The method of claim 19, wherein the first characterization comprises a thermal calibration of the material.

29. The method of claim 19, further comprising:
interrupting the application of the predetermined power after heating the material,
measuring a second radiative thermal flux emitted by the material,
calculating based on the measurement of the second radiative thermal flux, an amount of heat that the material lost by thermal diffusion from a central region of the material towards a wall of the well, and
determining a second characterization of the material based on the amount of heat lost by said thermal diffusion.

30. The method of claim 29, further comprising measuring the second radiative thermal flux by infrared thermography.

31. The method of claim 29, wherein calculating the amount of heat lost by the material by thermal diffusion includes comparing the measurement of the second radiative thermal flux with a measurement of a second reference radiative thermal flux,
wherein the second reference radiative thermal flux is emitted by a reference material comprising the same type of material under the same conditions, with the exception that the predetermined power is not applied to the reference material.

32. The method of claim 31, further comprising measuring the second reference radiative thermal flux by infrared thermography.

33. The method of claim 29, wherein the second characterization comprises a thermal calibration of the material.

34. The method of claim 19, wherein the material comprises alumina, silica, zeolite, alumino-silicate minerals, rare earth oxides, polymers, organic molecules, or mixtures thereof.

35. The method of claim 34, wherein the alumina, silica, zeolite, alumino-silicate minerals, or rare earth oxides are loaded with at least one noble metal.

36. A method for determining a thermodynamic characteristic of a probe molecule, comprising:
placing a solid powdery material to be characterized in a well,
applying a predetermined power to heat said material,
measuring a first radiative thermal flux emitted by the material,
calculating an amount of heat lost by the material via heat conduction with a surface of the well based on the measurement of the first radiative thermal flux, and
determining a first characterization of the material based on the amount of heat lost;
said method further comprising:
percolating a gas mixture comprising the probe molecule through the material,
wherein said probe molecule interacts with the material,
measuring a third radiative thermal flux emitted by the material, and
determining at least one thermodynamic characteristic of the probe material based on the first characterization and the measurement of the third radiative thermal flux.

37. A method for determining a thermodynamic characteristic of a probe molecule, comprising:
placing a solid powdery material to be characterized in a well,
applying a predetermined power to heat said material,
measuring a first radiative thermal flux emitted by the material,
calculating an amount of heat lost by the material via heat conduction with a surface of the well based on the measurement of the first radiative thermal flux, and
determining a first characterization of the material based on the amount of heat lost;
said method further comprising:
applying a predetermined power to heat said material,
interrupting the application of the predetermined power after heating the material,
measuring a second radiative thermal flux emitted by the material,
calculating based on the measurement of the second radiative thermal flux, an amount of heat that the material lost by thermal diffusion from a central region of the material towards a wall of the well, and
determining a second characterization of the material based on the amount of heat lost by said thermal diffusion;
said method further comprising:
percolating a gas mixture comprising the probe molecule through the material,
wherein said probe molecule interacts with the material,
measuring a third radiative thermal flux emitted by the material, and
determining at least one thermodynamic characteristic of the probe material based on the first and second characterizations and the measurement of the third radiative thermal flux.

38. The method of claim 36, wherein the at least one thermodynamic characteristic comprises the vaporization enthalpy of the probe molecule.

39. The method of claim 37, wherein the at least one thermodynamic characteristic comprises the vaporization enthalpy of the probe molecule.

40. The method of claim 36, wherein the probe molecule comprises a hydrocarbon, a soot, a volatile organic compound, carbon monoxide, carbon dioxide, a carboxylic acid, an alkane, an alkyne, an alkene, an alcohol, an aromatic compound, a thiol, an ester, a ketone, an aldehyde, an amide, an amine, ammonia, lutidine, a pyridine, hydrogen, fluorine, neon, a nitrile, quinoline, or a mixture thereof.

41. The method of claim 37, wherein the probe molecule comprises a hydrocarbon, a soot, a volatile organic compound, carbon monoxide, carbon dioxide, a carboxylic acid, an alkane, an alkyne, an alkene, an alcohol, an aromatic compound, a thiol, an ester, a ketone, an aldehyde, an amide, an amine, ammonia, lutidine, a pyridine, hydrogen, fluorine, neon, a nitrile, quinoline, or a mixture thereof.

42. The method of claim 36, wherein the probe molecule interacts with the material by adsorption.

43. The method of claim 37, wherein the probe molecule interacts with the material by adsorption.

44. A characterization device comprising:
at least one well comprising a bottom adapted to receive a powdery material to be characterized,
a heating element in the bottom of the at least one well adapted to heat the material by applying a predetermined power while said heating element is in contact with and covered by the material, and
a measurement device for measuring a radiative thermal flux emitted by the material adapted to observe a mouth of the at least one well from outside the well.

45. The characterization device of claim 44, wherein the heating element comprises an electric resistor powered by a generator providing the predetermined power.

46. The characterization device of claim 44, wherein the measurement device comprises an infrared camera.

47. The characterization device of claim 44, wherein the device comprises more than one well observable by the measurement device.

48. A characterization device comprising:
at least one well comprising a bottom adapted to receive a powdery material to be characterized,
a heating element in the bottom of the at least one well adapted to heat the material by applying a predetermined power while said heating element is in contact with and covered by the material,
a measurement device for measuring a radiative thermal flux emitted by the material adapted to observe a mouth of the at least one well from outside the well, and
an inlet opening into the bottom of the at least one well for a gas mixture comprising a probe molecule capable of interacting with the material.
